(19) United States
(12) Patent Application Publication
(10) Pub. No.: US 2005/0104808 A1
(43) Pub. Date: May 19, 2005

(54) Plasma display panel and method of driving the same

(75) Inventor: Yukinori Kashio, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC PLASMA DISPLAY CORPORATION

(21) Appl. No.: 10/950,538

(22) Filed: Sep. 28, 2004

(30) Foreign Application Priority Data
Nov. 19, 2003 (JP) 2003-388953

(51) Int. Cl. G09G 3/28

(52) U.S. Cl. 345/60

(57) ABSTRACT

There is provided a method of driving a plasma display panel including a first substrate, a second substrate, and a plurality of display cells. The first substrate includes a first electrode, and a second electrode extending in parallel with the first electrode and defining a display line with the first electrode therebetween. The second substrate includes a third electrode facing the first and second electrodes, and extends in such a direction which intersects with a direction in which the first and second electrodes extend. The display cells are arranged at intersections of the first and second electrodes with the third electrode. The method includes the step of applying a voltage having such a serrate waveform that a voltage varies with the lapse of time, to at least one of the first and second electrodes, a final voltage of a sustaining-eliminating voltage being higher than a final voltage of a priming-eliminating voltage.

### BACKGROUND OF THE INVENTION

1. Field of the Invention

The invention relates to a plasma display panel and a method of driving the same, and more particularly to an AC memory operation type plasma display panel and a method of driving the same.

2. Description of the Related Art

A plasma display panel (PDP) has advantages that a plasma display panel has less flickers than other display units such as a cathode ray tube (CRT) and a liquid crystal display device, a plasma display panel has a greater contrast ratio than a contrast ratio of other display units, a plasma display panel is thinner than other display units, a plasma display panel is suitable for fabrication of a big screen, and a plasma display panel has a higher response speed than other display units. Hence, a plasma display panel is much used as a display unit of a data processor such as a computer.

A plasma display panel is grouped into two types in accordance with its operation. Specifically, a plasma display panel is grouped into a direct current (DC) type panel having an electrode exposed to a discharge space and operating in a condition of direct-current discharges, and an alternate current (AC) type panel having an electrode covered with a transparent dielectric layer such that the electrode is not exposed directly to a discharge space, and operating in a condition of alternate-current discharges. Furthermore, an alternate current (AC) type panel is grouped further into a memory operation type panel making use of a memory function caused by accumulation of electric charges in a dielectric layer, and a refresh operation type panel not making use of such a memory function.

An alternate current (AC) type plasma display panel has a simpler structure than the same of a direct current (DC) type plasma display panel, and is more suitable for fabrication of a big screen than a direct current (DC) type plasma display panel. Thus, an alternate current (AC) type plasma display panel is used much more than a direct current (DC) type plasma display panel.

FIG. 1 is an exploded perspective view of a conventional plasma display panel. Hereinbelow is explained a structure of a plasma display panel with reference to FIG. 1.

A plasma display panel 70 illustrated in FIG. 1 is comprised of a front substrate 71 and a rear substrate 72 facing each other. Between the front and rear substrates 71 and 72 is formed a discharge gas space 73.

As illustrated in FIG. 1, the front substrate 71 is comprised of a first electrically insulating substrate 74 composed of transparent material such as glass, a scanning electrode 75 formed on an inner surface of the first electrically insulating substrate 74, a common (sustain) electrode 76 formed in parallel with the scanning electrode 75 on an inner surface of the first electrically insulating substrate 74, a transparent dielectric layer 77 covering the scanning electrode 75 and the common electrode 76 therewith and composed of fusible glass such as lead oxide (PbO), and a protection film 78 formed covering the transparent dielectric layer 77 therewith for protecting the transparent dielectric layer 77 from discharges.

The scanning electrode 75 is comprised of a transparent electrode 75A extending in a horizontal direction H on an inner surface of the first electrically insulating substrate 74, and composed of transparent material such as indium-tin oxide (ITO), and a bus (trace) electrode 75B formed on the transparent electrode 75A for reducing an electric resistance of the transparent electrode 75A, and composed of aluminum (Al), copper (Cu) or silver (Ag).

The common (sustain) electrode 76 is comprised of a transparent electrode 76A extending in a horizontal direction H on an inner surface of the first electrically insulating substrate 74, and composed of transparent material such as indium-tin oxide (ITO), and a bus (trace) electrode 76B formed on the transparent electrode 76A for reducing an electric resistance of the transparent electrode 76A, and composed of aluminum (Al), copper (Cu) or silver (Ag).

The rear substrate 72 is comprised of a second electrically insulating substrate 81 composed of transparent material such as glass, a data (address) electrode 83 extending in a vertical direction V on an inner surface of the second electrically insulating substrate 81, and composed of aluminum (Al), copper (Cu) or silver (Ag), a white dielectric layer 84 formed on the second electrically insulating substrate 81, covering the data electrode 83 therewith, a partition wall (rib) 85 extending in the vertical direction V to partition the discharge gas space 73 into discharge cells, and composed of fusible glass, and a fluorescent material layer 86 covering sidewalls of the partition wall 85 and exposed surfaces of the white dielectric layer 84 therewith.

The fluorescent material layer 86 transforms ultra-violet ray emitted because of discharges of the discharge gas, into visible light, and is comprised of a red fluorescent material layer for emitting red light, a green fluorescent material layer for emitting green light, and blue fluorescent material layer for emitting blue light.

The discharge space 73 is filled with discharge gas comprised of helium (He), neon (Ne) and xenon (Xe) alone or in combination.

FIG. 2 illustrates waveforms of voltages to be applied to the scanning electrode 75, the common electrode 76 and the data electrode 83 while the plasma display panel 70 illustrated in FIG. 1 is being driven, and waveforms of lights emitted from the plasma display panel 70. The waveforms of lights emitted from the plasma display panel 70, illustrated in FIG. 2, are found when the previous sub-field is selected, and this sub-field is not selected.

FIGS. 3A to 3E illustrate generation and annihilation of electric charges on the scanning electrode 75, the common electrode 76 and the data electrode 83.

Hereinbelow is explained a method of driving the plasma display panel 70 with reference to FIGS. 2 and 3A to 3E. FIGS. 3A to 3E show electric charges at the timings (A), (B), (C), (D) and (E) illustrated in FIG. 2.

As illustrated in FIG. 2, a cycle for driving the plasma display panel 70 is comprised of a reset period for eliminating data having been displayed in the previous sub-field, a scanning period for selecting a display cell or display cells in which data is to be displayed, and a sustaining period for actually displaying images.

Different voltages are applied to each of the scanning electrodes 75, and similarly, different voltages are applied to each of the data electrodes 83. A common voltage having a certain waveform is applied to the common electrodes 76.

First, as illustrated in FIG. 2, in the reset period, a pulse Pse for eliminating sustaining discharges is applied to all of the scanning electrodes 75 to generate eliminating discharges. As a result, wall charges having been accumulated due to sustaining-discharge pulses are eliminated. The pulse Pse for eliminating sustaining discharges is a pulse voltage having a serrate or inclined waveform in which a voltage linearly varies with the lapse of time.

Specifically, since the display cell emitted a light (namely, generated discharges in a sustaining period) in the previous sub-field, negative and positive wall charges are accumulated on the dielectric layer 77 above the scanning and common electrodes 75 and 76, respectively, at the timing (A) shown in FIG. 2, as illustrated in the left of FIG. 3A.

Applying the pulse Pse to the scanning electrodes 75, weak discharges 50 and 51 are generated between the scanning electrodes 75 and the common electrodes 76 and between the scanning electrodes 75 and the data electrodes 83, respectively, resulting in that wall charges having been generated due to sustaining discharges in the previous sub-field are eliminated. Thus, as illustrated in the right of FIG. 3A, no wall charges are accumulated above the scanning electrodes 75, the common electrodes 76 and the data electrodes 83.

Then, a positive priming pulse Pp+ is applied to all of the scanning electrodes 75, ensuring a light is compulsively emitted in all of the display cells. While the positive priming pulse Pp+ is being applied to the scanning electrodes 75, a negative priming pulse Pp− is applied to the common electrodes 76.

Immediately before the positive and negative priming pulses Pp+ and Pp− are applied to the scanning electrodes 75 and the common electrodes 76, as illustrated in the left of FIG. 3B, wall charges are already eliminated and hence do not exist on the scanning electrodes 75, the common electrodes 76 and the data electrodes 83. Thus, at the timing (B) immediately after the positive and negative priming pulses Pp+ and Pp− are applied to the scanning electrodes 75 and the common electrodes 76, as illustrated in the right of FIG. 3B, discharges are not generated between the scanning electrodes 75 and the common electrodes 76 and between the scanning electrodes 75 and the data electrodes 83.

As illustrated in the left of FIG. 3C, weak discharges 52 and 53 are generated between the scanning electrodes 75 and the common electrodes 76 and between the scanning electrodes 75 and the data electrodes 83, respectively, at the timing (C) while the positive and negative priming pulses Pp+ and Pp− are being applied to the scanning electrodes 75 and the common electrodes 76, respectively. As a result, as illustrated in the right of FIG. 3C, negative electric charges 61 are accumulated above the scanning electrodes 75, ad positive electric discharges 62 are accumulated above the common electrodes 76 and the data electrodes 83.

Then, a priming-eliminating pulse Ppe is applied to all of the scanning electrodes 75 to thereby generate eliminating discharges for eliminating wall charges having been accumulated above the scanning electrodes 75, the common electrodes 76 and the data electrodes 83 due to the positive priming pulse Pp+.

Specifically, as illustrated in the left of FIG. 3D, eliminating or weak discharges 54 and 55 are generated between the scanning electrodes 75 and the common electrodes 76 and between the scanning electrodes 75 and the data electrodes 83, respectively, at the timing (D) illustrated in FIG. 2, due to the priming-eliminating pulse Ppe. As a result, as illustrated in the right of FIG. 3D, wall charges accumulated above the scanning electrodes 75, the common electrodes 76 and the data electrodes 83 are eliminated or reduced.

Then, a scanning base pulse Pbe is applied to the scanning electrodes 75 in a scanning period. In a selected display cell, a scanning base pulse Pbw is applied to the scanning electrodes 75, and a data pulse is applied to the data electrodes 83, resulting in generation of discharge therebetween. Since FIG. 2 illustrates waveforms of voltages in a non-selected display cell, a data pulse is not applied to the data electrodes 83 illustrated in FIG. 2, and accordingly, there is not generated discharge.

Thus, as illustrated in the left and right of FIG. 3E, wall charges accumulated above the scanning electrodes 75, the common electrodes 76 and the data electrodes 83 are kept as they are, at the timing (E) which is during the scanning base pulse Pbw is being applied to the scanning electrodes 75.

The positive priming pulse Pp+ and the priming-eliminating pulse Ppe both illustrated in FIG. 2 have an inclined or serrate waveform in which a voltage gradually raises or lowers with the lapse of time. Discharge generated by such a pulse having an inclined or serrate waveform is weak discharge which expands only around the discharge gas space 73.

The above-mentioned operation of the plasma display panel 70 is an ideal operation in a reset period and a scanning period.

As illustrated in FIG. 2, in a conventional method of driving a plasma display panel, a final voltage of the pulse Pse for eliminating sustaining discharges is equal to a final voltage of the priming-eliminating pulse Ppe. For instance, Japanese Patent Application Publications Nos. 2000-67761 and 2003-295814 suggest that a final voltage of the pulse Pse for eliminating sustaining discharges is equal to a final voltage of the priming-eliminating pulse Ppe.

However, when the plasma display panel 70 is driven in accordance with the voltages having the waveforms illustrated in FIG. 2, the plasma display panel 70 often operates in a manner different from the above-mentioned ideal operation, in which case, a light is emitted from a non-selected display cell(s), resulting in deterioration in display quality of the plasma display panel 70.

FIGS. 4A to 4E illustrate generation and annihilation of electric charges on the scanning electrode 75, the common electrode 76 and the data electrode 83. FIGS. 4A to 4E correspond to FIGS. 3A to 3E. Hereinbelow is explained the reason why a light is emitted from a non-selected display cell(s), with reference to FIGS. 4A to 4E.

As mentioned earlier, the pulse Pse for eliminating sustaining discharges is applied to all of the scanning electrodes 75 in a reset period to thereby generate discharges for eliminating sustaining-discharges. As a result, wall charges having been accumulated due to sustaining-discharge pulses are eliminated. Since the discharges for eliminating sustaining-discharges are generated immediately after generation of sustaining-discharges, there exist a lot of active particles in a display cell when a sustaining-discharge pulse is applied to the scanning electrodes 75. Accordingly, discharge for eliminating sustaining-discharges is likely to be more intensive than priming-eliminating discharges. If discharge for eliminating sustaining-discharges is too intensive or a threshold voltage at which discharge is generated between the scanning and common electrodes 75 and 76 is low, wall charges are eliminated by the discharge for eliminating sustaining-discharges, and in addition, positive electric charges 63 and negative electric charges 64 may be accumulated on the dielectric layer 77 above the scanning electrodes 75 and the common electrodes 76, respectively, as illustrated in the right of FIG. 4A.

Hence, applying the positive priming pulse Pp+ to the scanning electrodes 75 subsequently to the pulse Pse, and further applying the negative priming pulse Pp− to the common electrodes 76, as illustrated in the left of FIG. 4B, there are generated discharges 56 and 57 between the scanning electrodes 75 and the common electrodes 76 and between the scanning electrodes 75 and the data electrodes 83, respectively.

As a result, as illustrated in FIGS. 4B, 4C, 4D and 4E, positive and negative wall charges are accumulated much more than normally accumulated wall charges illustrated in FIGS. 3B, 3C, 3D and 3E.

Thus, applying the scanning base pulse Pbw to the scanning electrodes 75, as illustrated in the left of FIG. 4E, wrong discharges 58 and 59 are generated between the scanning electrodes 75 and the common electrodes 76 and between the scanning electrodes 75 and the data electrodes 83, respectively. Due to the wrong discharges 58 and 59, a light is emitted from a non-selected display cell in a scanning period. That is, there occurs wrong light-emission 90 (see FIG. 2).

Similarly, in a sustaining period following a scanning period, when a sustaining pulse Ps is applied to the scanning electrodes 75, there are generated wrong discharges 58 and 59 due to which a light is emitted from a non-selected display cell in a sustaining period, that is, there occurs wrong light-emission 91 (see FIG. 2).

### SUMMARY OF THE INVENTION

In view of the above-mentioned problems in the conventional method of driving a plasma display panel, it is an object of the present invention to provide a method of driving a plasma display panel, which is capable of preventing generation of wrong discharges between scanning and common electrodes and between scanning and data electrodes, and thus, preventing wrong light-emission in a non-selected display cell.

It is also an object of the present invention to provide a plasma display panel capable of doing the same.

It is further an object of the present invention to provide a plasma display unit including such a plasma display panel.

Hereinbelow is described a method of driving a plasma display panel in accordance with the present invention through the use of reference numerals used in later described embodiments. The reference numerals are indicated only for the purpose of clearly showing correspondence between claims and the embodiments. It should be noted that the reference numerals are not allowed to interpret of claims of the present application.

In one aspect of the present invention, there is provided a method of driving a plasma display panel (70) including a first substrate (71), a second substrate (72), and a plurality of display cells. The first substrate (71) includes at least one first electrode (75), and at least one second electrode (76) extending in parallel with the first electrode (75) and defining a display line with the first electrode (75) therebetween. The second substrate (72) includes at least one third electrode (83) facing the first and second electrodes (75, 76), and extends in such a direction which intersects with a direction in which the first and second electrodes (75, 76) extend. The display cells are arranged at intersections of the first and second electrodes (75, 76) with the third electrode (83). The method includes the step of applying a voltage having such a serrate waveform that a voltage varies with the lapse of time, to at least one of the first and second electrodes (75, 76), wherein a final voltage (Vse) of a sustaining-eliminating voltage (Pse) is higher than a final voltage (Vpe) of a priming-eliminating voltage (Ppe).

For instance, the final voltage (Vse) of a sustaining-eliminating voltage (Pse) is a positive voltage, and the final voltage (Vpe) of a priming-eliminating voltage is a grounded voltage (Ppe).

As an alternative, the final voltage (Vse) of a sustaining-eliminating voltage (Pse) is a grounded voltage, and the final voltage (Vpe) of a priming-eliminating voltage (Ppe) is a negative voltage.

As an alternative, the final voltage (Vse) of a sustaining-eliminating voltage (Pse) is a positive voltage, and the final voltage (Vpe) of a priming-eliminating voltage (Ppe) is a negative voltage.

As an alternative, the final voltage (Vse) of a sustaining-eliminating voltage (Pse) and the final voltage (Vpe) of a priming-eliminating voltage (Ppe) are positive voltages.

The final voltage (Vse) of a sustaining-eliminating voltage (Pse) may be set in each of sub-fields.

For instance, the final voltage (Vse) of a sustaining-eliminating voltage (Pse) may be determined by varying a width of the sustaining-eliminating voltage (Pse).

It is preferable that the final voltage (Vse) of a sustaining-eliminating voltage (Pse) is in the range of 5 to 180 V both inclusive.

It is more preferable that the final voltage (Vse) of a sustaining-eliminating voltage (Pse) is in the range of 40 to 160 V both inclusive.

It is preferable that the sustaining-eliminating voltage (Pse) has a waveform having a greater inclination than an inclination of a waveform of the priming-eliminating voltage (Ppe).

For instance, it is preferable that the sustaining-eliminating voltage (Pse) has a waveform having an inclination in the range of 2.5 to 8 V/microsecond both inclusive, and priming-eliminating voltage (Ppe) has a waveform having an inclination in the range of 2.5 to 4 V/microsecond both inclusive.

In another aspect of the present invention, there is provided a plasma display panel (70) including a first substrate (71), a second substrate (72), a plurality of display cells, and a controller (102). The first substrate (71) includes at least one first electrode (75), and at least one second electrode (76) extending in parallel with the first electrode (75) and defining a display line with the first electrode (75) therebetween. The second substrate (72) includes at least one third electrode (83) facing the first and second electrodes (75, 76), and extends in such a direction which intersects with a direction in which the first and second electrodes (75, 76) extend. The display cells are arranged at intersections of the first and second electrodes (75, 76) with the third electrode (83). The controller (102) controls application of voltages to the first to third electrodes (75, 76, 83). The controller applies a voltage having such a serrate waveform that a voltage varies with the lapse of time, to at least one of the first and second electrodes (75, 76). The controller defines a final voltage (Vse) of a sustaining-eliminating voltage (Pse) being higher than a final voltage (Vpe) of a priming-eliminating voltage (Ppe).

For instance, the controller (102) defines the final voltage (Vse) of a sustaining-eliminating voltage (Pse) to be a positive voltage, and the final voltage (Vpe) of a priming-eliminating voltage (Ppe) to be a grounded voltage.

As an alternative, the controller (102) defines the final voltage (Vse) of a sustaining-eliminating voltage (Pse) to be a grounded voltage, and the final voltage (Vpe) of a priming-eliminating voltage (Ppe) to be a negative voltage.

As an alternative, the controller (102) defines the final voltage (Vse) of a sustaining-eliminating voltage (Pse) to be a positive voltage, and the final voltage (Vpe) of a priming-eliminating voltage (Ppe) to be a negative voltage.

As an alternative, the controller (102) defines the final voltage (Vse) of a sustaining-eliminating voltage (Pse) and the final voltage (Vpe) of a priming-eliminating voltage (Ppe) to be positive voltages.

The controller (102) may set the final voltage (Vse) of a sustaining-eliminating voltage (Pse) in each of sub-fields.

For instance, the controller (102) may determine the final voltage (Vse) of a sustaining-eliminating voltage (Pse) by varying a width of the sustaining-eliminating voltage (Pse).

It is preferable that the controller (102) determines the final voltage (Vse) of a sustaining-eliminating voltage (Pse) in the range of 5 to 180 V both inclusive.

It is more preferable that the controller (102) determines the final voltage (Vse) of a sustaining-eliminating voltage (Pse) in the range of 40 to 160 V both inclusive.

It is preferable that the controller (102) causes the sustaining-eliminating voltage (Pse) to have a waveform having a greater inclination than an inclination of a waveform of the priming-eliminating voltage (Ppe).

For instance, the controller (102) causes the sustaining-eliminating voltage (Pse) to have a waveform having an inclination in the range of 2.5 to 8 V/microsecond both inclusive, and further, causes the priming-eliminating voltage (Ppe) to have a waveform having an inclination in the range of 2.5 to 4 V/microsecond both inclusive.

In still another aspect of the present invention, there is provided a plasma display unit including the above-mentioned plasma display panel, and driver circuits for driving the plasma display panel.

The advantages obtained by the aforementioned present invention will be described hereinbelow.

In accordance with the present invention, a final voltage of a sustaining-eliminating voltage is set higher than a final voltage of a priming-eliminating voltage. This ensures it possible to prevent excessive generation of wall charges due to sustaining-eliminating discharges. As a result, it is possible to prevent unintentional discharges, that is, wrong discharges to be generated when a voltage varies, and it is further possible to prevent wrong light-emission, that is, light-emission in a non-selected display cell, ensuring qualified images without flickers.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is an exploded perspective view of a plasma display panel.

FIG. 2 illustrates waveforms of voltages to be applied to electrodes while the plasma display panel illustrated in FIG. 1 is being driven, and waveforms of lights emitted from the plasma display panel.

FIGS. 3A to 3E illustrate generation and annihilation of electric charges on a scanning electrode, a common electrode and a data electrode.

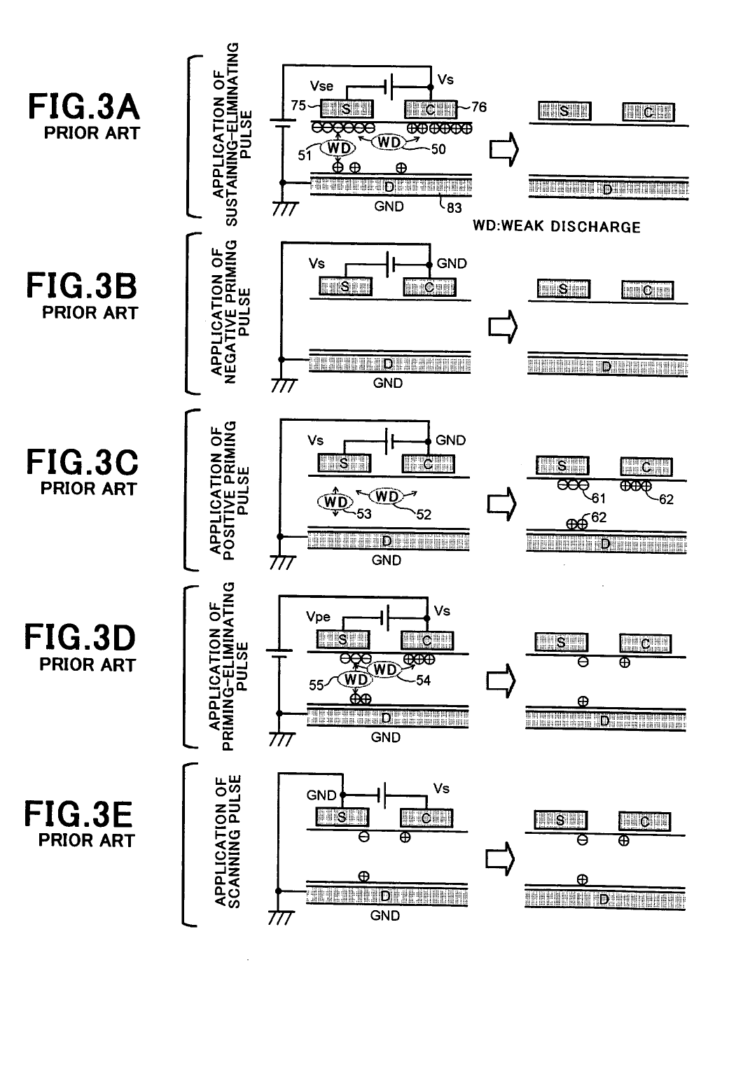

FIGS. 4A to 4E illustrate generation and annihilation of electric charges on a scanning electrode, a common electrode and a data electrode.

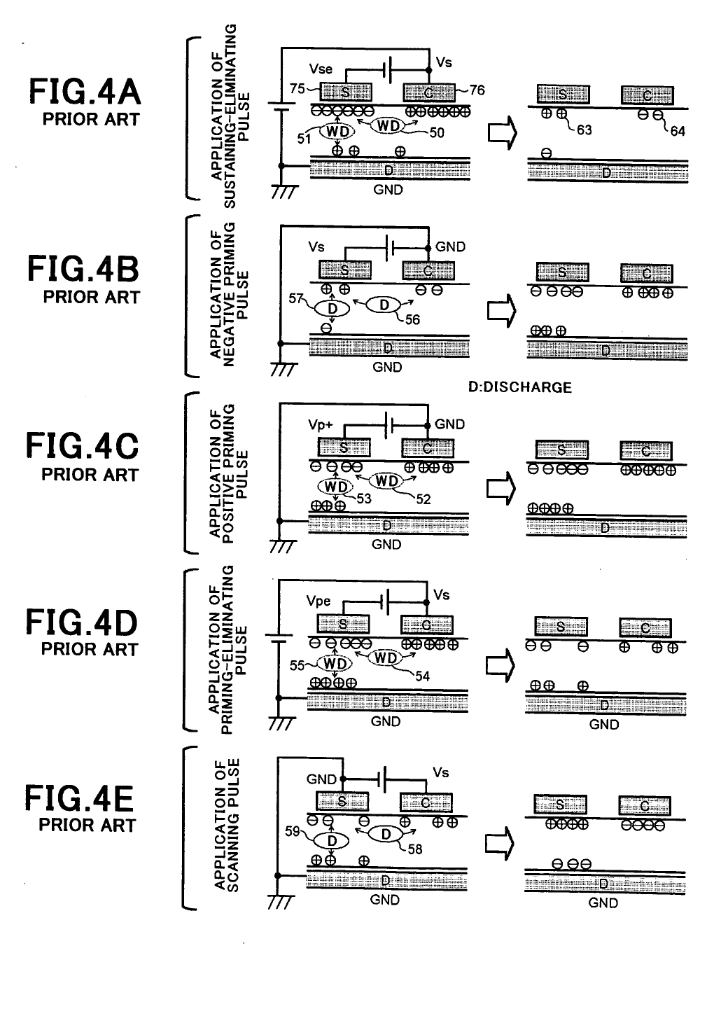

FIG. 5 illustrates waveforms of voltages to be applied to electrodes in a method of driving a plasma display panel, in accordance with the first embodiment of the present invention.

FIG. 6 is a graph showing a relation between a final voltage of a sustaining-eliminating voltage and a margin of a driving voltage.

FIG. 7 illustrates waveforms of voltages to be applied to electrodes in a method of driving a plasma display panel, in accordance with the second embodiment of the present invention.

FIG. 8 illustrates waveforms of voltages to be applied to electrodes in a method of driving a plasma display panel, in accordance with the third embodiment of the present invention.

FIG. 9 illustrates waveforms of voltages to be applied to electrodes in a method of driving a plasma display panel, in accordance with the fourth embodiment of the present invention.

FIG. 10 is a block diagram of a plasma display unit in accordance with the fifth embodiment of the present invention.

### DESCRIPTION OF THE PREFERRED EMBODIMENTS

Preferred embodiments in accordance with the present invention will be explained hereinbelow with reference to drawings.

### First Embodiment

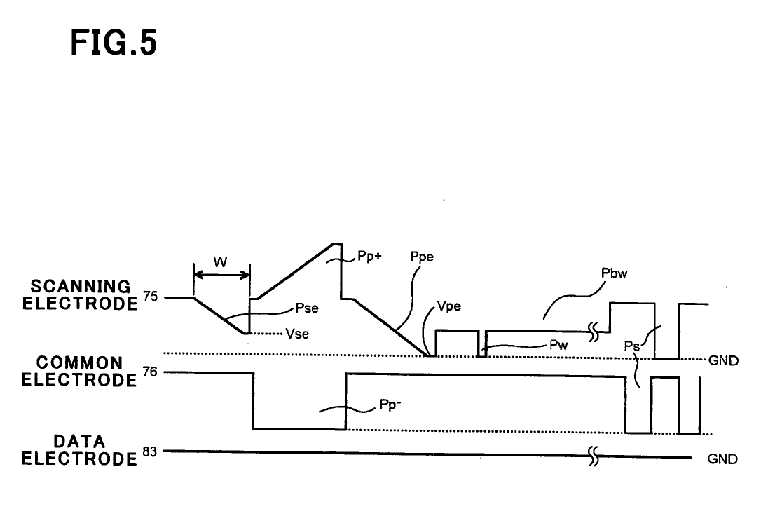

FIG. 5 illustrates waveforms of voltages to be applied to electrodes in a method of driving a plasma display panel, in accordance with the first embodiment of the present invention.

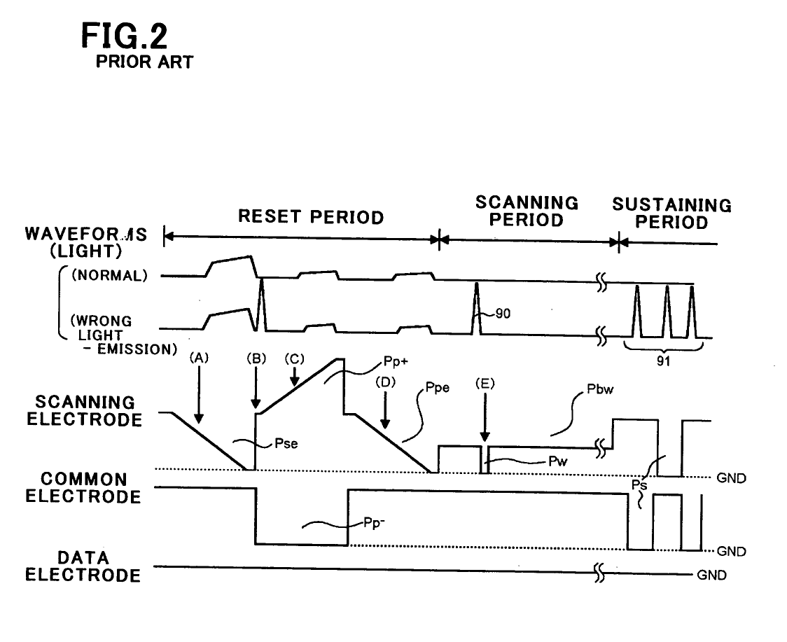

As illustrated in FIG. 2, a final voltage of a sustaining-eliminating voltage indicated as the pulse Pse for eliminating sustaining-discharge is set equal to a grounded voltage in a conventional method of driving a plasma display panel. In contrast, in the first embodiment, a final voltage Vse of a sustaining-eliminating voltage indicated as the pulse Pse for eliminating sustaining-discharge is set equal to a certain positive voltage.

A final voltage Vpe of a priming-eliminating voltage indicated as the priming-eliminating pulse Ppe is set equal to a grounded voltage, similarly to a final voltage of a priming-eliminating voltage in the conventional method illustrated in FIG. 2.

That is, the final voltage Vpe of a sustaining-eliminating voltage is set higher than the final voltage Vpe of a priming-eliminating voltage, and hence, there is a voltage difference between the final voltage Vse and the final voltage Vpe.

By setting the final voltage Vpe of a sustaining-eliminating voltage higher than the final voltage Vpe of a priming-eliminating voltage, it is possible to prevent excessive generation of wall charges due to sustaining-eliminating discharges. As a result, if the negative priming pulse Pp− is applied to the common electrodes 76 at a next stage, it would be possible to prevent generation of wrong or unintentional discharges. This ensures that wrong light-emission, that is, light-emission in a non-selected display cell can be prevented, and that qualified images can be displayed without flickers.

A volume of active particles vary in dependence on the number of sustaining-discharges generated in the previous sub-field. Accordingly, a discharge intensity of sustaining-eliminating discharge is in proportion with the number of sustaining-discharges generated in the previous sub-field. Hence, it is possible to optimize the final voltage Vse of a sustaining-eliminating voltage in each of sub-fields.

In order to vary the final voltage Vse of a sustaining-eliminating voltage, it would be necessary to prepare a plurality of voltage sources providing different voltage from one another, for instance. As an alternative, the final voltage Vse of a sustaining-eliminating voltage may be varied by varying a width W of the pulse Pse for eliminating sustaining-discharge (see FIG. 5). Specifically, if the width W of the pulse Pse is set shorter, the final voltage Vse can be set higher, and if the width W of the pulse Pse is set longer, the final voltage Vse can be set lower. Thus, it would be possible to set the different final voltages Vse in each of sub-fields without an increase in the number of voltage sources and/or switching circuits, by varying the width W of the pulse Pse.

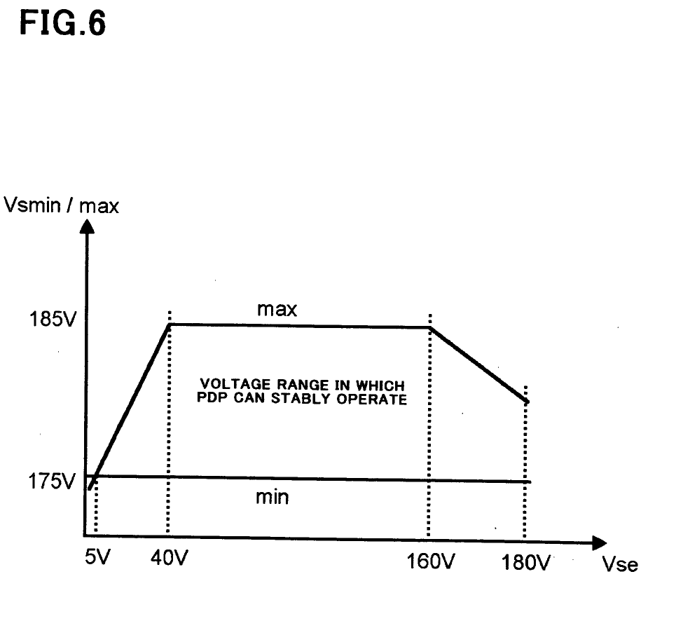

FIG. 6 is a graph showing a margin of a driving voltage with the final voltage Vse being varied in the range of 50 to 180 V. The margin was measured through the user of a 60-inch plasma display panel.

As illustrated in FIG. 6, whereas a minimum voltage Vsmin at which a light is emitted from a selected display cell is almost constant, specifically, equal to about 175 V, a maximum voltage Vsmax at which wrong light-emission is not generated, that is, a light is not emitted from a non-selected display cell varies as the final voltage Vse of a sustaining-eliminating voltage varies. At a voltage between the minimum voltage Vsmin and the maximum voltage Vsmax, a plasma display panel operates without occurrence of wrong light-emission.

If the final voltage Vse rises in the range of 5 to 40V, a voltage at which wrong light-emission occurs linearly raises as the final voltage Vse raises.

When the final voltage Vse reaches 40V, the maximum voltage Vsmax reaches about 185V. The maximum voltage Vsmax is kept at about 185V, until the final voltage Vse reaches about 160V.

If the final voltage Vse is over 160V, a voltage at which wrong light-emission occurs linearly lowers as the final voltage Vse lowers. This is because that sustaining-eliminating discharge is too weak, and hence, priming discharge is not generated.

As mentioned above, when the final voltage Vse is in the range of 5V to 180V both inclusive, there can be obtained a margin of a driving voltage. When the final voltage Vse is in the range of 40V to 160V both inclusive, a voltage range in which a plasma display panel can stably operate is in maximum.

Accordingly, it would be possible to stably drive a plasma display panel without occurrence of wrong light-emission by setting the final voltage Vse higher than the final voltage Vpe with the final voltage Vse being varied in the range of 5V to 180V both inclusive. In particular, it would be possible to most stably drive a plasma display panel by setting the final voltage Vse higher than the final voltage Vpe with the final voltage Vse being varied in the range of 40V to 160V both inclusive.

In the first embodiment, the final voltage Vse of a sustaining-eliminating voltage is set equal to a certain positive voltage, and the final voltage Vpe of a priming-eliminating voltage is set equal to a grounded voltage for generating a voltage difference therebetween. However, the final voltage Vpe of a priming-eliminating voltage may be set equal to a voltage other than a grounded voltage. Unless the final voltage Vpe is lower than the final voltage Vse, the final voltage Vpe may be set equal to a positive voltage.

### Second Embodiment

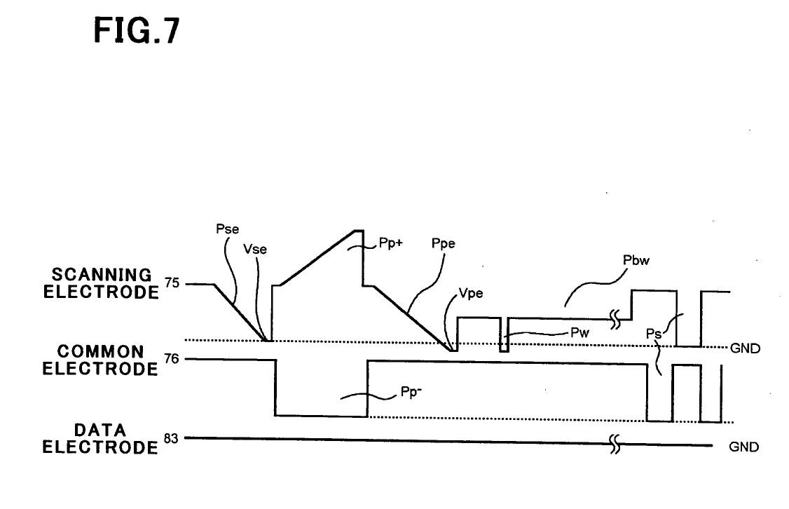

FIG. 7 illustrates waveforms of voltages to be applied to electrodes in a method of driving a plasma display panel, in accordance with the second embodiment of the present invention.

In the above-mentioned first embodiment, the final voltage Vse of a sustaining-eliminating voltage is set equal to a certain positive voltage, and the final voltage Vpe of a priming-eliminating voltage is set equal to a grounded voltage for generating a voltage difference between the final voltages Vse and Vpe. In the second embodiment, as illustrated in FIG. 7, the final voltage Vse of a sustaining-eliminating voltage is set equal to a grounded voltage, and the final voltage Vpe of a priming-eliminating voltage is set equal to a certain negative voltage lower than a grounded voltage, for generating a voltage difference between the final voltages Vse and Vpe.

In the second embodiment, the final voltage Vse of a sustaining-eliminating voltage is set equal to a final voltage (that is, a grounded voltage) of sustaining-eliminating voltage in the conventional method of driving a plasma display panel, and the final voltage Vpe of a priming-eliminating voltage is set lower than a final voltage (that is, a grounded voltage) of a priming-eliminating voltage in the conventional method of driving a plasma display panel. Thus, similarly to the first embodiment, the second embodiment makes it possible to prevent excessive generation of wall charges due to sustaining-eliminating discharges, and further prevent occurrence of wrong or unintentional discharges. This ensures that qualified images can be displayed without wrong or unintentional light-emission and further without flickers.

### Third Embodiment

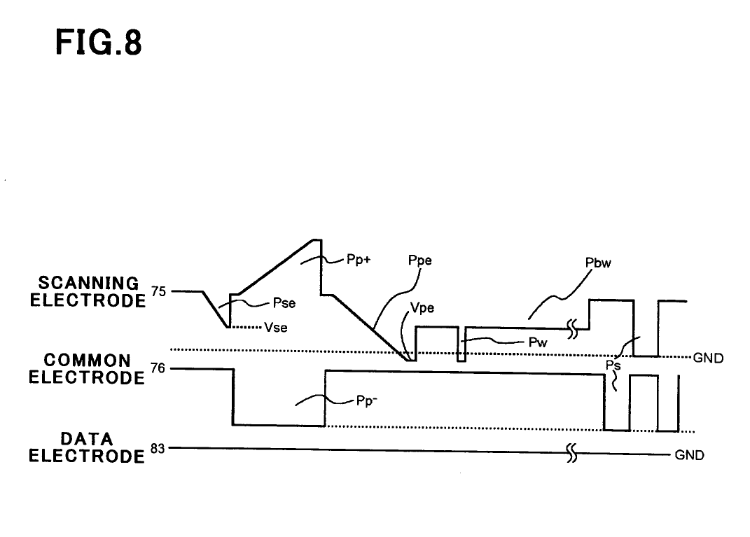

FIG. 8 illustrates waveforms of voltages to be applied to electrodes in a method of driving a plasma display panel, in accordance with the third embodiment of the present invention.

In the third embodiment, as illustrated in FIG. 8, the final voltage Vse of a sustaining-eliminating voltage is set equal to a certain positive voltage higher than a grounded voltage, and the final voltage Vpe of a priming-eliminating voltage is set equal to a certain negative voltage lower than a grounded voltage. As a result, there can be obtained a greater voltage difference between the final voltages Vse and Vpe than the same obtained in the first and second embodiments.

Similarly to the first embodiment, the third embodiment makes it possible to prevent excessive generation of wall charges due to sustaining-eliminating discharges, and further prevent occurrence of wrong or unintentional discharges. This ensures that qualified images can be displayed without wrong or unintentional light-emission and further without flickers.

In addition, when a particular voltage difference is to be generated, the third embodiment makes it possible to set a difference between the final voltage Vse and a grounded voltage and a difference between the final voltage Vpe and a grounded voltage smaller than those in the first and second embodiments.

### Fourth Embodiment

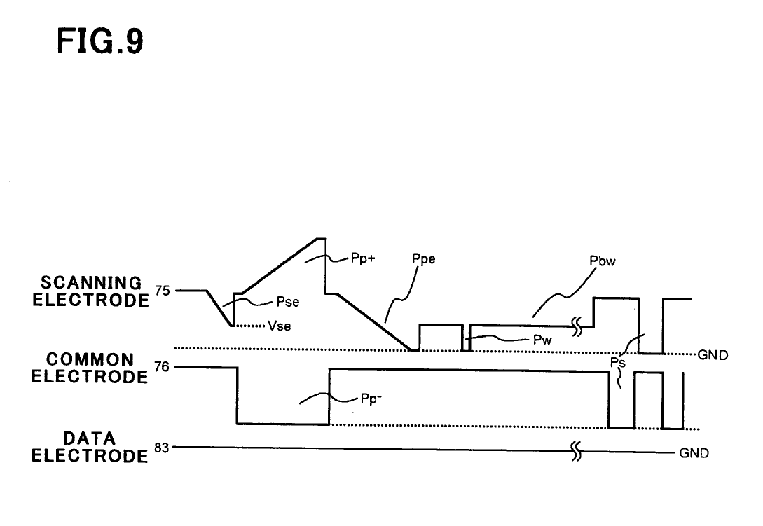

FIG. 9 illustrates waveforms of voltages to be applied to electrodes in a method of driving a plasma display panel, in accordance with the fourth embodiment of the present invention.

The pulse Pse for eliminating sustaining discharges in the fourth embodiment is designed to have an inclination greater than an inclination of the priming-eliminating pulse Ppe.

For instance, the pulse Pse is designed to have an inclination which is in the range of 2.5 to 8 V/μs both inclusive, and which is greater than an inclination of the priming-eliminating pulse Ppe.

By designing the pulse Pse to have an increased inclination, it would be possible to shorten a period of time for driving the scanning electrodes 75. In addition, by assigning a difference between an original period of time and a shortened period of time to a sustaining period, it would be possible to increase the number of sustaining discharges, raise a brightness, increase the number of sub-fields, and enhance display quality such as gray scales.

The fourth embodiments may be applied to the second or third embodiment as well as the first embodiment.

### Fifth Embodiment

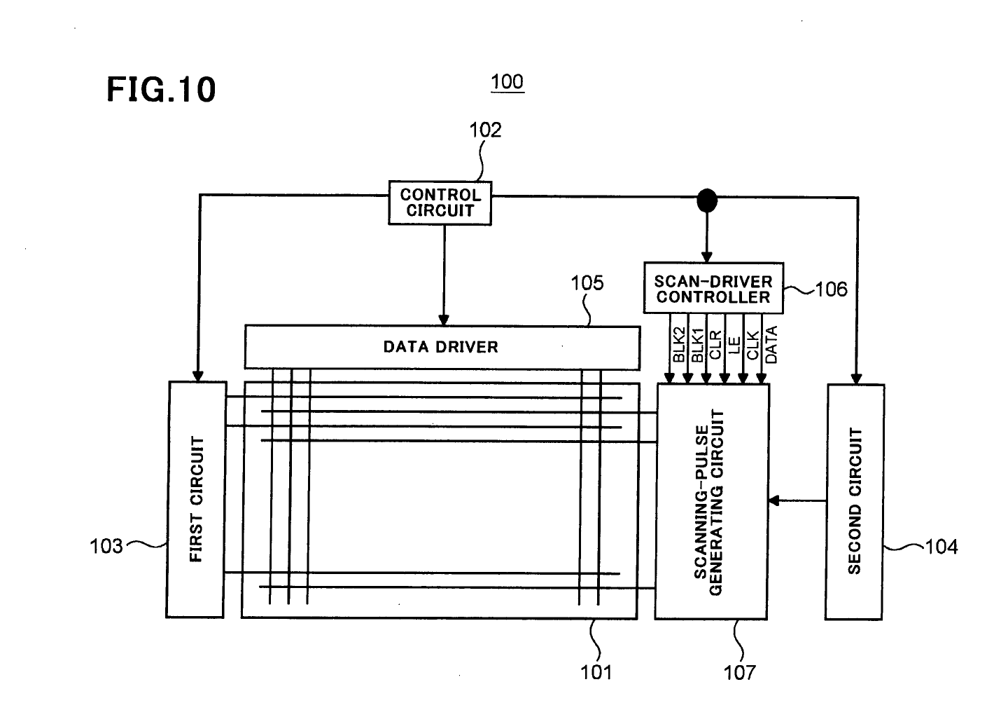

FIG. 10 is a block diagram of a plasma display unit in accordance with the fifth embodiment of the present invention.

As illustrated in FIG. 10, a plasma display unit 100 is comprised of a plasma display panel 101 for displaying images therein, a control circuit 102 which controls image-displaying in the plasma display panel 101, a first circuit 103 which is controlled by the control circuit 102 to generate sustaining-discharge pulses, and which transmits the thus generated sustaining-discharge pulses to the plasma display panel 101, a second circuit 104 which is controlled by the control circuit 102 to generate sustaining-discharge pulses, and which transmits the thus generated sustaining-discharge pulses to a later-mentioned scanning-pulse generating circuit 107, a data driver 105 which is controlled by the control circuit 102 to transfer image data to the plasma display panel 101, a scan-driver controller 106 which is controlled by the control circuit 102 to control scan-drivers included in a later-mentioned scanning-pulse generating circuit 107, and a scanning-pulse generating circuit 107 which is controlled by the scan-driver controller 106 and the second circuit 104 to generate scanning pulses, and transmit the thus generated scanning pulses to the plasma display panel 101 for driving the scanning electrodes 75.

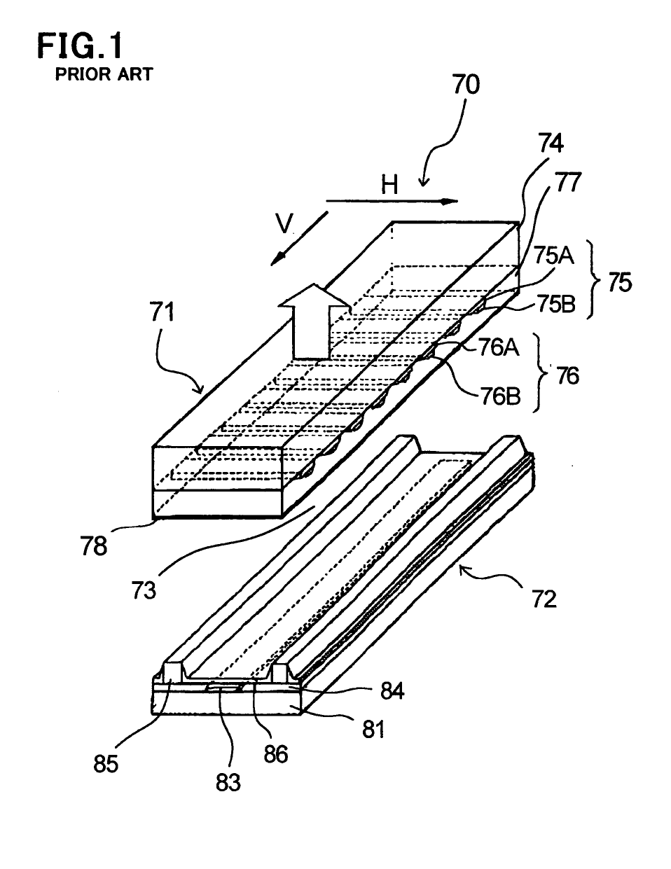

The plasma display panel 101 has the same structure as the plasma display panel 70 illustrated in FIG. 1.

The control circuit 102 may be incorporated in the plasma display panel 101.

The control circuit 102 controls the scanning-pulse generating circuit 107 to define a relation between the final voltage Vse of a sustaining-eliminating voltage and the final voltage Vpe of a priming-eliminating voltage. That is, the control circuit 102 sets the final voltage Vse higher than the final voltage Vpe.

Specifically, the control circuit 102 sets the final voltage Vse of a sustaining-eliminating voltage indicated as the pulse Pse for eliminating sustaining-discharge equal to a certain positive voltage, and further sets the final voltage Vpe of a priming-eliminating voltage indicated as the priming-eliminating pulse Ppe equal to a grounded voltage, as explained in the above-mentioned first embodiment. As an alternative, the control circuit 102 sets the final voltage Vse sets equal to a grounded voltage, and further sets the final voltage Vpe equal to a negative voltage lower than a grounded voltage, as explained in the above-mentioned second embodiment. As an alternative, the control circuit 102 sets the final voltage Vse sets equal to a positive voltage, and further sets the final voltage Vpe equal to a negative voltage lower than a grounded voltage, as explained in the above-mentioned third embodiment.

The control circuit 102 controls the scanning-pulse generating circuit 107 such that the pulse Pse has an inclination greater than an inclination of the priming-eliminating pulse Ppe, as explained in the above-mentioned fourth embodiment.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2003-388953 filed on Nov. 19, 2003 including specification, claims, drawings and summary is incorporated herein by reference in its entirety.

1. A method of driving a plasma display panel including a first substrate, a second substrate, and a plurality of display cells,
said first substrate including at least one first electrode, and at least one second electrode extending in parallel with said first electrode and defining a display line with said first electrode therebetween,
said second substrate including at least one third electrode facing said first and second electrodes, and extending in such a direction which intersects with a direction in which said first and second electrodes extend,
said display cells being arranged at intersections of said first and second electrodes with said third electrode,
said method including the step of applying a voltage having such a serrate waveform that a voltage varies with the lapse of time, to at least one of said first and second electrodes,
a final voltage of a sustaining-eliminating voltage being higher than a final voltage of a priming-eliminating voltage.

2. The method as set forth in claim 1, wherein said final voltage of a sustaining-eliminating voltage is a positive voltage, and said final voltage of a priming-eliminating voltage is a grounded voltage.

3. The method as set forth in claim 1, wherein said final voltage of a sustaining-eliminating voltage is a grounded voltage, and said final voltage of a priming-eliminating voltage is a negative voltage.

4. The method as set forth in claim 1, wherein said final voltage of a sustaining-eliminating voltage is a positive voltage, and said final voltage of a priming-eliminating voltage is a negative voltage.

5. The method as set forth in claim 1, wherein said final voltage of a sustaining-eliminating voltage and said final voltage of a priming-eliminating voltage are positive voltages.

6. The method as set forth in claim 1, wherein said final voltage of a sustaining-eliminating voltage is set in each of sub-fields.

7. The method as set forth in claim 1, wherein said final voltage of a sustaining-eliminating voltage is determined by varying a width of said sustaining-eliminating voltage.

8. The method as set forth in claim 1, wherein said final voltage of a sustaining-eliminating voltage is in the range of 5 to 180 V both inclusive.

9. The method as set forth in claim 8, wherein said final voltage of a sustaining-eliminating voltage is in the range of 40 to 160 V both inclusive.

10. The method as set forth in claim 1, wherein said sustaining-eliminating voltage has a waveform having a greater inclination than an inclination of a waveform of said priming-eliminating voltage.

11. The method as set forth in claim 10, wherein said sustaining-eliminating voltage has a waveform having an inclination in the range of 2.5 to 8 V/microsecond both inclusive, and priming-eliminating voltage has a waveform having an inclination in the range of 2.5 to 4 V/microsecond both inclusive.

12. A plasma display panel including a first substrate, a second substrate, a plurality of display cells, and a controller,
said first substrate including at least one first electrode, and at least one second electrode extending in parallel with said first electrode and defining a display line with said first electrode therebetween,
said second substrate including at least one third electrode facing said first and second electrodes, and extending in such a direction which intersects with a direction in which said first and second electrodes extend,
said display cells being arranged at intersections of said first and second electrodes with said third electrode,
said controller controlling application of voltages to said first to third electrodes,
said controller applying a voltage having such a serrate waveform that a voltage varies with the lapse of time, to at least one of said first and second electrodes,
said controller defining a final voltage of a sustaining-eliminating voltage being higher than a final voltage of a priming-eliminating voltage.

13. The plasma display panel as set forth in claim 12, wherein said controller defines said final voltage of a sustaining-eliminating voltage to be a positive voltage, and said final voltage of a priming-eliminating voltage to be a grounded voltage.

14. The plasma display panel as set forth in claim 12, wherein said controller defines said final voltage of a sustaining-eliminating voltage to be a grounded voltage, and said final voltage of a priming-eliminating voltage to be a negative voltage.

15. The plasma display panel as set forth in claim 12, wherein said controller defines said final voltage of a sustaining-eliminating voltage to be a positive voltage, and said final voltage of a priming-eliminating voltage to be a negative voltage.

16. The plasma display panel as set forth in claim 12, wherein said controller defines said final voltage of a sustaining-eliminating voltage and said final voltage of a priming-eliminating voltage to be positive voltages.

17. The plasma display panel as set forth in claim 12, wherein said controller sets said final voltage of a sustaining-eliminating voltage in each of sub-fields.

18. The plasma display panel as set forth in claim 12, wherein said controller determines said final voltage of a sustaining-eliminating voltage by varying a width of said sustaining-eliminating voltage.

19. The plasma display panel as set forth in claim 12, wherein said controller determines said final voltage of a sustaining-eliminating voltage in the range of 5 to 180 V both inclusive.

20. The plasma display panel as set forth in claim 19, wherein said controller determines said final voltage of a sustaining-eliminating voltage in the range of 40 to 160 V both inclusive.

21. The plasma display panel as set forth in claim 12, wherein said controller causes said sustaining-eliminating voltage to have a waveform having a greater inclination than an inclination of a waveform of said priming-eliminating voltage.

22. The plasma display panel as set forth in claim 21, wherein said controller causes said sustaining-eliminating voltage to have a waveform having an inclination in the range of 2.5 to 8 V/microsecond both inclusive, and further, causes said priming-eliminating -voltage to have a waveform having an inclination in the range of 2.5 to 4 V/microsecond both inclusive.

23. A plasma display unit comprising:
a plasma display panel; and
driver circuits for driving said plasma display panel,
said plasma display panel including a first substrate, a second substrate, a plurality of display cells, and a controller,
said first substrate including at least one first electrode, and at least one second electrode extending in parallel with said first electrode and defining a display line with said first electrode therebetween,
said second substrate including at least one third electrode facing said first and second electrodes, and extending in such a direction which intersects with a direction in which said first and second electrodes extend,
said display cells being arranged at intersections of said first and second electrodes with said third electrode,
said controller controlling application of voltages to said first to third electrodes,
said controller applying a voltage having such a serrate waveform that a voltage varies with the lapse of time, to at least one of said first and second electrodes,
said controller defining a final voltage of a sustaining-eliminating voltage being higher than a final voltage of a priming-eliminating voltage.
